(19) United States
(12) Patent Application Publication
(10) Pub. No.: US 2019/0040246 A1
(43) Pub. Date: Feb. 7, 2019

(54) FLAME-RETARDANT RUBBER COMPOSITION AND EXTERNAL DIAPHRAGM FOR RAILROAD CAR

(71) Applicant: Sumitomo Riko Company Limited, Komaki-shi (JP)

(72) Inventors: Keiichi Muratani, Komaki-shi (JP); Kenji Yamamoto, Komaki-shi (JP)

(73) Assignee: Sumitomo Riko Company Limited, Komaki-shi (JP)

(21) Appl. No.: 16/156,081

(22) Filed: Oct. 10, 2018

Related U.S. Application Data
(63) Continuation of application No. PCT/JP2017/023399, filed on Jun. 26, 2017.

(30) Foreign Application Priority Data
Jul. 29, 2016 (JP) 2016-149393

(51) Int. Cl. C08L 23/16; B61D 17/22

(52) U.S. Cl. CPC C08L 23/16; B61D 17/22; C08L 2312/02; C08L 2205/025; C08L 2201/02

(57) ABSTRACT

Provided is a flame-retardant rubber composition including the following components (A) to (D): (A) An olefin-based rubber, (B) An acid-modified polyolefin, (C) A metal hydroxide, and (D)

A cross-1 inking agent for the component (A). A content of the component (C) with respect to 100 parts by weight of a total content of the component (A) and the component (B) falls within a range of from 100 parts by weight to 350 parts by weight. Also provided is an external diaphragm for railroad cars including a cross-linked product of the flame-retardant rubber composition. Thus, there can be provided a flame-retardant rubber composition excellent in rubber physical properties, such as tensile strength and breaking elongation, and durability, and also excellent in flame retardancy, and an external diaphragm for railroad cars obtained using the flame-retardant rubber composition.

### RELATED APPLICATION

This application is a continuation of International Application No. PCT/JP2017/023399, filed on Jun. 26, 2017, which claims priority to Japanese Patent Application No. 2016-149393, filed on Jul. 29, 2016, the entire contents of each of which are hereby incorporated by reference.

### TECHNICAL FIELD

The present disclosure relates to a flame-retardant rubber composition to be used for an external diaphragm for railroad cars or the like, and an external diaphragm for railroad cars obtained using the flame-retardant rubber composition.

### BACKGROUND ART

An external diaphragm is arranged between railroad cars (in a car connecting portion) mainly for the purposes of, for example, preventing a person from falling off a platform into a space formed between cars of a train, and reducing air resistance of the connecting portion between cars. As such external diaphragm for railroad cars, there is used, for example, a white or gray rubber-made external diaphragm formed of an ethylene-propylene-diene rubber (EPDM) or the like (see, for example, Patent Literature 1).

Incidentally, the external diaphragm for railroad cars has been conventionally required to have flame retardancy, and tends to have strict flame retardancy requirements particularly in some foreign countries. A generally known approach to making a rubber flame-retardant is to add a flame retardant, such as a halogen-based flame retardant, a phosphorus-based flame retardant, or a hydroxide, to the rubber (see, for example, Patent Literatures 2 to 4).

### RELATED ART DOCUMENTS

### Patent Documents

PTL 1: JP-B2-4853485

PTL 2: JP-A-HEI7(1995)-166047

PTL 3: JP-A-2005-146256

PTL 4: JP-A-2009-227695

### SUMMARY OF INVENTION

However, the halogen-based flame retardant has a problem of generating black smoke at the time of its combustion, and a problem of adversely affecting the environment.

Meanwhile, the phosphorus-based flame retardant and the hydroxide do not have such problems as those of the halogen-based flame retardant. However, in order to express their flame retardant effects, the phosphorus-based flame retardant and the hydroxide each need to be added in a large amount into the rubber, thus being liable to serve as a factor in reducing the durability of the rubber. Besides, each of the phosphorus-based flame retardant and the hydroxide has a low interaction with the rubber, and also has a large particle diameter as compared to the particle diameter of silica or carbon black. Accordingly, each of the phosphorus-based flame retardant and the hydroxide is liable to serve as an origin of rubber fracture, and has a risk of serving as a factor in reducing rubber physical properties, such as tensile strength and breaking elongation.

The present disclosure has been made in view of such circumstances, and an object of the present disclosure is to provide a flame-retardant rubber composition excellent in rubber physical properties, such as tensile strength and breaking elongation, and durability, and also excellent in flame retardancy, and an external diaphragm for railroad cars obtained using the flame-retardant rubber composition.

In order to achieve the above-mentioned object, according to a first embodiment of the present disclosure, there is provided a flame-retardant rubber composition, including the following components (A) to (D): (A) an olefin-based rubber; (B) an acid-modified polyolefin; (C) a metal hydroxide; and (D) a cross-linking agent for the component (A). A content of the component (C) with respect to 100 parts by weight of a total content of the component (A) and the component (B) falls within a range of from 100 parts by weight to 350 parts by weight.

In addition, according to a second embodiment of the present disclosure, there is provided an external diaphragm for railroad cars, including a cross-linked product of the flame-retardant rubber composition according to the first embodiment.

That is, the inventors have made extensive investigations in order to solve the above-mentioned problems. During the course of the investigations, the inventors have ascertained that, when an acid-modified polyolefin is added into a rubber composition containing an olefin-based rubber, such as EPDM, as a polymer, and a metal hydroxide as a flame retardant, satisfactory flame retardancy can be expressed even if the blending amount of the metal hydroxide is reduced to fall within a specific range. A possible reason for this is that an acid-modified group in the acid-modified polyolefin has a high bonding property for the metal hydroxide, and the resultant acid-modified polyolefin having bonded thereto the metal hydroxide shows a satisfactory interaction with the olefin-based rubber (in some cases, the acid-modified polyolefin and the olefin-based rubber are co-cross-linked), with the result that the acid-modified polyolefin shows a coupling action between the olefin-based rubber and the metal hydroxide to enhance the dispersibility of the metal hydroxide in the olefin-based rubber. In addition, the inventors have found that, as a result of the above-mentioned reduction in blending amount of the metal hydroxide, and the above-mentioned coupling action which the acid-modified polyolefin shows while showing excellent flexibility, the rubber composition shows tensile strength, breaking elongation, and the like required of an external diaphragm for railroad cars, and obtains excellent durability. Thus, the inventors have achieved the present disclosure.

As described above, the flame-retardant rubber composition of the present disclosure contains the olefin-based rubber (A), the acid-modified polyolefin (B), the specific amount of the metal hydroxide (C), and the cross-linking agent (D). As a result, the flame-retardant rubber composition of the present disclosure exhibits excellent effects on rubber physical properties, such as tensile strength and breaking elongation, and durability, and also exhibits an excellent effect on flame retardancy. Accordingly, the flame-retardant rubber composition of the present disclosure can exhibit excellent performance particularly as a material for forming a cover, such as an external diaphragm for railroad cars.

In particular, when a content ratio of the olefin-based rubber (A) and the acid-modified polyolefin (B) falls within the range of A/B=95/5 to 70/30 in terms of weight ratio, satisfactory rubber physical properties and durability can be obtained as well as satisfactory dispersibility of the metal hydroxide (C).

In addition, when the cross-linking agent (D) includes an organic peroxide, a problem of yellowing due to acid rain can be eliminated.

In addition, when the olefin-based rubber (A) includes at least one of an ethylene-propylene-diene rubber (EPDM) and chlorosulfonated polyethylene (CSM), the rubber composition is more excellent in durability and the like.

In addition, when the acid-modified polyolefin (B) includes a maleic acid-modified polyolefin, excellent dispersibility of the metal hydroxide is obtained. In particular, when the acid-modified polyolefin (B) includes a maleic acid-modified poly-α-olefin, compatibility with the olefin-based rubber is satisfactory, resulting in more excellent mechanical properties.

In addition, when the metal hydroxide (C) includes at least one of aluminum hydroxide and magnesium hydroxide, a more excellent flame retardant effect can be obtained.

In addition, the external diaphragm for railroad cars including the cross-linked product of the flame-retardant rubber composition of the present disclosure is excel lent in rubber physical properties, such as tensile strength and breaking elongation, and durability, and is also excellent in flame retardancy.

### DESCRIPTION OF EMBODIMENTS

Next, an embodiment of the present disclosure is described in detail.

As described above, a flame-retardant rubber composition of the present disclosure contains an olefin-based rubber (A), an acid-modified polyolefin (B), a specific amount of a metal hydroxide (C), and a cross-linking agent (D). As a result, the flame-retardant rubber composition of the present disclosure exhibits excellent effects on rubber physical properties, such as tensile strength and breaking elongation, and durability, and also exhibits an excellent effect on flame retardancy. Accordingly, the flame-retardant rubber composition of the present disclosure can exhibit excellent performance particularly as a material for forming a cover, such as an external diaphragm for railroad cars. In the present disclosure, the “olefin-based rubber” means a rubber that is a polymer containing an olefin, and that is cross-linkable. As a cross-linkable functional group of the olefin-based rubber, there are given, for example, an active methylene group, methine group, and methyl group each of which is adjacent to an olefinic double bond.

«Olefin-based Rubber (Component A)»

Examples of the olefin-based rubber (A) include ethylene-propylene-based rubbers, such as an ethylene-propylene-diene rubber (EPDM) and an ethylene-propylene copolymer rubber (EPM), chlorosulfonated polyethylene (CSM), a polyisobutylene rubber, a polyisobutyl ether rubber, a polycyclopentene rubber, and a butyl rubber. Those rubbers maybe used alone or in combination. Of those, anethylene-propylene-diene rubber (EPDM) and chlorosulfonated polyethylene (CSM) are suitably used from the viewpoint of being more excellent in durability and the like.

«Acid-modified Polyolefin (Component B)»

Examples of the acid-modified polyolefin (B) include products each obtained by modifying, with an acid, any of polyolefin resins (excluding the olefin-based rubber (A)), such as a poly-α-olefin, high-density polyethylene (HDPE), polyethylene, polypropylene, polybutene, and polymethylpentene. Those acid-modified polyolefins may be used alone or in combination. The modification with an acid may be performed with, for example, an unsaturated carboxylic acid, polylactic acid, phosphoric acid, or a sulfonic acid. In addition, examples of the unsaturated carboxylic acid include acrylic acid, methacrylic acid, maleic acid, maleic anhydride, itaconic acid, itaconic anhydride, fumaric acid, crotonic acid, a half ester of an unsaturated dicarboxylic acid, a half amide of an unsaturated dicarboxylic acid, phthalic acid, cinnamic acid, glutaconic acid, citraconic anhydride, aconitic anhydride, andnadic acid. In addition, a modified group obtained through the modification with an acid may be arranged on a terminal of a polyolefin molecular chain or in the middle of the molecular chain (molecular chain nonterminal).

Of those, the acid-modified polyolef in (B) is preferably a maleic acid-modified polyolefin from the viewpoint of the dispersibility of the metal hydroxide, and is more preferably a maleic acid-modified poly-α-olefin from the same viewpoint.

In addition, the content ratio of the olefin-based rubber (A) and the acid-modified polyolefin (B) falls within preferably the range of A/B=95/5 to 70/30, more preferably the range of A/B=95/5 to 80/20 in terms of weight ratio. That is, when such content ratio is adopted, satisfactory rubber physical properties and durability can be obtained as well as satisfactory dispersibility of the metal hydroxide (C).

«metal Hydroxide (Component C)»

At least one of aluminum hydroxide and magnesium hydroxide is preferably used as the metal hydroxide (C) because a more excellent flame retardant effect can be obtained.

In addition, the content of the metal hydroxide (C) is required to fall within the range of from 100 parts by weight to 350 parts by weight with respect to 100 parts by weight of the total content of the olefin-based rubber (A) and the acid-modified polyolefin (B), and falls within the range of preferably from 150 parts by weight to 300 parts by weight, more preferably from 150 parts by weight to 250 parts by weight. That is, such range is adopted for the following reasons: when the content of the metal hydroxide (C) is lower than the range, a desired flame retardant effect cannot be obtained; and when the content of the metal hydroxide (C) is higher than the range, process ability is deteriorated and mechanical strength is deteriorated.

«Cross-linking Agent (Component D)»

Depending on the kind of the olefin-based rubber (A) to be used, a cross-linking agent capable of cross-linking the olefin-based rubber is used as the cross-linking agent (D). In addition, examples of the cross-linking agent (D) include: sulfur-based cross-linking agents, such as sulfur and sulfur chloride; and organic peroxides, such as 2,4-dichlorobenzoyl peroxide, benzoyl peroxide, 1,1-di-t-butylperoxy-3,3,5-trimethylcyclohexane, 2,5-dimethyl-2,5-dibenzoylperoxyhexane, n-butyl-4,4′-di-t-butylperoxyvalerate, dicumyl peroxide, t-butylperoxy benzoate, di-t-butylperoxy-diisopropylbenzene, t-butylcumylperoxide,2,5-dimethyl-2,5-di(t-butylperoxy)hexane, di-t-butyl peroxide, 2,5-dimethyl-2,5-di-t-butylperoxy hexyne-3, and 1,3-bis-(t-butylperoxy-isopropyl)benzene. Those cross-linking agents (D) may be used alone or in combination. Of those, an organic peroxide is preferred as the cross-linking agent (D) because a problem of yellowing due to acid rain can be eliminated, and hence the rubber composition can exhibit excellent performance as a material for forming a cover, such as an external diaphragm for railroad cars.

The content of the cross-linking agent (D) falls within preferably the range of from 0.5 part by weight to 15 parts by weight, more preferably the range of from 0.5 part by weight to 10 parts by weight with respect to 100 parts by weight of the total content of the olefin-based rubber (A) and the acid-modified polyolefin (B). That is, such range is adopted because of the following reasons : when the content of the cross-linking agent (D) is excessively low, there is observed such a tendency that tensile strength is reduced; and when the content of the cross-linking agent (D) is excessively high, there is observed such a tendency that scorch resistance is deteriorated and elongation is reduced.

As required, a reinforcing agent (e.g., carbon black, silica, or talc), a vulcanization accelerator, a vulcanization aid, a co-cross-linking agent, an anti-aging agent, a process oil, and the like may be appropriately blended into the flame-retardant rubber composition of the present disclosure in addition to the components (A) to (D).

The flame-retardant rubber composition of the present disclosure may be prepared, for example, in the following manner. That is, the olefin-based rubber (A), the acid-modified polyolefin (B), the specific amount of the metal hydroxide (C), and as required, the reinforcing agent, the anti-aging agent, the process oil, and the like are appropriately blended. With the use of a Banbury mixer or the like, kneading of those components is started at a temperature of about 50° C., followed by kneading at from 100° C. to 160° C. for from about 3 minutes to about 5 minutes. Next, the kneaded product is appropriately blended with the cross-linking agent (D), the co-cross-linking agent, the vulcanization accelerator, the vulcanization aid, and the like, followed by kneading using an open roll under predetermined conditions (e.g., 60° C.×5 minutes). Thus, the flame-retardant rubber composition may be prepared. After that, the resultant flame-retardant rubber composition maybe cross-linked at a high temperature (of from 150° C. to 170° C.) for from 5 minutes to 60 minutes to provide a flame-retardant rubber (cross-linked product).

The flame-retardant rubber composition of the present disclosure can exhibit excellent performance particularly as a material for forming a cover, such as an external diaphragm for railroad cars. An example of the cover other than the external diaphragm for railroad cars is a soft top for an automobile. In addition, an external diaphragm for railroad cars including a cross-linked product of the flame-retardant rubber composition of the present disclosure is excellent in rubber physical properties, such as tensile strength and breaking elongation, and durability, and is also excellent in flame retardancy.

### EXAMPLES

Next, Examples are described together with Comparative Examples. However, the present disclosure is not limited to these Examples.

First, prior to Examples and Comparative Examples, the following materials were prepared.

[EPDM (Component (A))]

ESPRENE 512F, manufactured by Sumitomo Chemical Co., Ltd.

[Acid-Modified Polyolefin (Component (B))]

TAFMER MH7020, manufactured by Mitsui Chemicals, Inc.

[Polyolefin]

TAFMER DF740, manufactured by Mitsui Chemicals, Inc.

[Zinc Oxide]

Zinc Oxide No. 2, manufactured by Sakai Chemical Industry Co., Ltd.

[Stearic Acid]

Stearic acid “Sakura”, manufactured by NOF Corporation

[Aluminum Hydroxide (Component (C))]

HIGILITE H-42M, manufactured by Showa Denko K.K.

[Magnesium Hydroxide (Component (C))]KISUMA 5, manufactured by Kyowa Chemical Industry Co., Ltd.

[Peroxide Cross-linking Agent (Component (D))]

Percumyl D-40, manufactured by NOF Corporation

[Co-Cross-Linking Agent]

Hi-Cross ED-P, manufactured by Seiko Chemical Co., Ltd.

[Sulfur]

Sulfur, manufactured by Karuizawa Refinery

[Vulcanization Accelerator-1]

SANCELER BZ, manufactured by Sanshin Chemical Industry Co., Ltd.

[Vulcanization Accelerator-2]

SANCELER TT, manufactured by Sanshin Chemical Industry Co., Ltd.

[Vulcanization Accelerator-3]

SANCELER TRA, manufactured by Sanshin Chemical Industry Co., Ltd.

[Vulcanization Accelerator-4]

VULNOC R, manufactured by Ouchi Shinko Chemical Industrial Co., Ltd.

### EXAMPLES 1 TO 10 AND COMPARATIVE EXAMPLES 1 TO 4

Components shown in Table 1 and Table 2 below were blended at ratios shown in Table 1 and Table 2, and were kneaded using a Banbury mixer and an open roll to prepare rubber compositions.

The evaluations of respective properties were performed by using the rubber compositions of Examples and Comparative Examples thus obtained in accordance with the following criteria. The results are also shown in Table 1 and Table 2 below.

[Processability]

The Mooney viscosity of each of the rubber compositions (kneaded products) was measured at a test temperature of 121° C. in conformity with JIS K6300-1 (2001). Then, a case in which the Mooney viscosity (ML₁₊₄ 121° C.) was less than 70 was indicated by “∘∘”, a case in which the Mooney viscosity was 70 or more and less than 100 was indicated by “∘”, and a case in which the Mooney viscosity was 100 or more was indicated by “×”.

[Tensile Strength and Breaking Elongation]

Each of the rubber compositions was subjected to press molding (vulcanized) under the conditions of 150° C.×20 minutes to produce a rubber sheet having a thickness of 2 mm. Then, a JIS No. 5 dumbbell was punched out of the rubber sheet, and its tensile strength and elongation at break (breaking elongation) were measured in conformity with JIS K6251 (2010). A case in which the tensile strength was 10 MPa or more was indicated by “∘∘”, a case in which the tensile strength was 7 MPa or more and less than 10 MPa was indicated by “∘”, and a case in which the tensile strength was less than 7 MPa was indicated by “×”. In addition, a case in which the breaking elongation was 600% or more was indicated by “∘∘”, a case in which the breaking elongation was 500% or more and less than 600% was indicated by “∘” , and a case in which the breaking elongation was less than 500% was indicated by “×”.

[Dumbbell Fatigue Test]

Each of the rubber compositions was subjected to press molding (vulcanized) under the conditions of 150° C.×20 minutes to produce a rubber sheet having a thickness of 2 mm. Then, a JIS No. 3 dumbbell was punched out of the rubber sheet, and a dumbbell fatigue test (elongation test) was performed by using the dumbbell in conformity with JIS K6260. Then, such a dumbbell that the number of times of elongation at the time of its breaking (number of times at the time of the breaking) was 50,000 or more was indicated by “∘∘”, such a dumbbell that the number of times at the time of the breaking was 10,000 or more and less than 50,000 was indicated by “∘”, and such a dumbbell that the number of times at the time of the breaking was less than 10,000 was indicated by “×”.

[Light Permeability Test]

Each of the flame-retardant rubber compositions was subjected to press molding (vulcanized) under the conditions of 150° C.×60 minutes to produce a 76.2-millimeter square rubber block having a thickness of 25.4 mm. Then, in order for the flame retardancy of the rubber block to be evaluated, the light permeability of smoke produced at the time of the combustion of the rubber block was measured in conformity with ASTM E662. That is, such a rubber block that the Ds value (specific optical density) of the smoke 4 minutes after the initiation of heating in a non-flaming or flaming test was less than 50 was indicated by “∘∘”, such a rubber block that the Ds value was 50 or more and less than 200 was indicated by “∘”, and such a rubber block that the Ds value was 200 or more was indicated by “×”.

[Oxygen Index]

Each of the flame-retardant rubber compositions was subjected to press molding (vulcanized) under the conditions of 150° C.×20 minutes to produce a rubber sheet having a thickness of 2 mm. Then, in order to evaluate how burnable the rubber sheet was, the lowest oxygen concentration (vol. %) required for sustaining the combustion of the rubber sheet was measured in conformity with JIS K7201. Then, a case in which the oxygen index was 24 or more was indicated by “∘∘”, a case in which the oxygen index was 21 or more and less than 24 was indicated by “∘”, and a case in which the oxygen index was less than 21 was indicated by “×”.

TABLE 1
(part (s) by weight)

| | Example | | | | | | | | | |
|---|---|---|---|---|---|---|---|---|---|---|
| | 1 | 2 | 3 | 4 | 5 | 6 | 7 | 8 | 9 | 10 |
| EPDM | 95.0 | 95.0 | 95.0 | 95.0 | 95.0 | 95.0 | 90.0 | 80.0 | 70.0 | 95.0 |
| Acid-modified | 5.0 | 5.0 | 5.0 | 5.0 | 5.0 | 5.0 | 10.0 | 20.0 | 30.0 | 5.0 |
| polyolefin | | | | | | | | | | |
| Polyolefin | — | — | — | — | — | — | — | — | — | — |
| Zinc oxide | 5.0 | 5.0 | 5.0 | 5.0 | 5.0 | 5.0 | 5.0 | 5.0 | 5.0 | 5.0 |
| Stearic acid | 2.0 | 2.0 | 2.0 | 2.0 | 2.0 | 2.0 | 2.0 | 2.0 | 2.0 | 2.0 |
| Aluminum hydroxide | 100.0 | 200.0 | 250.0 | 300.0 | 350.0 | — | 200.0 | 200.0 | 200.0 | 200.0 |
| Magnesium hydroxide | — | — | — | — | — | 250.0 | — | — | — | — |
| Peroxide cross-linking | 4.0 | 4.0 | 4.0 | 4.0 | 4.0 | 4.0 | 4.0 | 4.0 | 4.0 | — |
| agent | | | | | | | | | | |
| Co-cross-linking agent | 5.0 | 5.0 | 5.0 | 5.0 | 5.0 | 5.0 | 5.0 | 5.0 | 5.0 | — |
| Sulfur | — | — | — | — | — | — | — | — | — | 0.6 |
| Vulcanization | — | — | — | — | — | — | — | — | — | 0.5 |
| accelerator-1 | | | | | | | | | | |
| Vulcanization | — | — | — | — | — | — | — | — | — | 0.5 |
| accelerator-2 | | | | | | | | | | |
| Vulcanization | — | — | — | — | — | — | — | — | — | 1.5 |
| accelerator-3 | | | | | | | | | | |
| Vulcanization | — | — | — | — | — | — | — | — | — | 1.7 |
| accelerator-4 | | | | | | | | | | |
| Processability | ∘∘ | ∘∘ | ∘∘ | ∘ | ∘ | ∘∘ | ∘∘ | ∘ | ∘ | ∘∘ |
| Tensile strength | ∘∘ | ∘∘ | ∘∘ | ∘ | ∘ | ∘∘ | ∘∘ | ∘∘ | ∘∘ | ∘ |
| Breaking elongation | ∘∘ | ∘∘ | ∘∘ | ∘ | ∘ | ∘∘ | ∘ | ∘ | ∘ | ∘ |
| Dumbbell fatigue test | ∘∘ | ∘∘ | ∘∘ | ∘ | ∘ | ∘∘ | ∘ | ∘ | ∘ | ∘ |
| Light permeability test | ∘ | ∘∘ | ∘∘ | ∘∘ | ∘∘ | ∘∘ | ∘∘ | ∘∘ | ∘∘ | ∘∘ |
| Oxygen index | ∘ | ∘∘ | ∘∘ | ∘∘ | ∘∘ | ∘∘ | ∘∘ | ∘∘ | ∘∘ | ∘∘ |

TABLE 2
(part(s) by weight)

| | Comparative Example | | | |
|---|---|---|---|---|
| | 1 | 2 | 3 | 4 |
| EPDM | 100.0 | 95.0 | 95.0 | 95.0 |
| Acid-modified polyolefin | — | — | 5.0 | 5.0 |
| Polyolefin | — | 5.0 | — | — |
| Zinc oxide | 5.0 | 5.0 | 5.0 | 5.0 |
| Stearic acid | 2.0 | 2.0 | 2.0 | 2.0 |
| Aluminum hydroxide | 200.0 | 200.0 | 80.0 | 400.0 |
| Magnesium hydroxide | — | — | — | — |
| Peroxide cross-linking agent | 4.0 | 4.0 | 4.0 | 4.0 |
| Co-cross-linking agent | 5.0 | 5.0 | 5.0 | 5.0 |
| Sulfur | — | — | — | — |
| Vulcanization accelerator-1 | — | — | — | — |
| Vulcanization accelerator-2 | — | — | — | — |
| Vulcanization accelerator-3 | — | — | — | — |
| Vulcanization accelerator-4 | — | — | — | — |
| Processability | ∘ | ∘∘ | ∘∘ | x |
| Tensile strength | x | x | ∘∘ | x |
| Breaking elongation | ∘ | ∘ | ∘∘ | x |
| Dumbbell fatigue test | ∘ | ∘ | ∘∘ | x |
| Light permeability test | ∘∘ | ∘ | x | ∘∘ |
| Oxygen index | ∘∘ | ∘ | x | ∘∘ |

It is found from the results shown in Table 1 that the rubber compositions of Examples are excellent in processability at the time of kneading, and rubber physical properties, such as tensile strength and breaking elongation, and also excellent in durability (dumbbell fatigue test), and have received high evaluations in the flame retardancy evaluations (light permeability test and oxygen index).

In contrast, the rubber compositions of Comparative Example 1 and Comparative Example 2, in each of which the acid-modified polyolefin (component (B)) was not blended, provided inferior results in tensile strength to those of Examples. The rubber composition of Comparative Example 3, in which the content of the metal hydroxide (component (C)) was excessively low, provided inferior results in flame retardant effect to those of Examples. The rubber composition of Comparative Example 4, in which the content of the metal hydroxide (component (C)) was excessively high, was deteriorated in processability, and was also deteriorated in mechanical strength (tensile strength, breaking elongation, and dumbbell fatigue test).

Although specific embodiments in the present disclosure have been described in Examples above, Examples above are for illustrative purposes only and are not to be construed as limitative. It is intended that various modifications apparent to a person skilled in the art fall within the scope of the present disclosure.

The flame-retardant rubber composition of the present disclosure exhibits excellent effects on rubber physical properties, such as tensile strength and breaking elongation, and durability, and also exhibits an excellent effect on flame retardancy. Accordingly, the flame-retardant rubber composition of the present disclosure can exhibit excellent performance particularly as a material for forming a cover, such as an external diaphragm for railroad cars. In addition to the external diaphragm for railroad cars, the flame-retardant rubber composition of the present disclosure may be used as a material for forming, for example, a soft top for an automobile.

1. A flame-retardant rubber composition, comprising:
(A) an olefin-based rubber;
(B) an acid-modified polyolefin;
(C) a metal hydroxide; and
(D) a cross-linking agent for the component (A).
wherein a content of the component (C) with respect to 100 parts by weight of a total content of the component (A) and the component (B) falls within a range of from 100 parts by weight to 350 parts by weight.

2. The flame-retardant rubber composition according to claim 1, wherein a content ratio of the olefin-based rubber (A) and the acid-modified polyolefin (B) falls within a range of A/B=95/5 to 70/30 in terms of weight ratio.

3. The flame-retardant rubber composition according to claim 1, wherein the cross-linking agent (D) comprises an organic peroxide.

4. The flame-retardant rubber composition according to claim 1, wherein the olefin-based rubber (A) comprises at least one of an ethylene-propylene-diene rubber (EPDM) and chlorosulfonated polyethylene (CSM).

5. The flame-retardant rubber composition according to claim 1, wherein the acid-modified polyolefin (B) comprises a maleic acid-modified polyolefin.

6. The flame-retardant rubber composition according to claim 5, wherein the maleic acid-modified polyolefin comprises a maleic acid-modified poly-α-olefin.

7. The flame-retardant rubber composition according to claim 1, wherein the metal hydroxide (C) comprises at least one of aluminum hydroxide and magnesium hydroxide.

8. The flame-retardant rubber composition according to claim 1, wherein the flame-retardant rubber composition is configured to be formed as a cover.

9. An external diaphragm for railroad cars, comprising:
a cross-linked product of the flame-retardant rubber composition of claim 1.
